(19) United States
(12) Patent Application Publication
(10) Pub. No.: US 2006/0153406 A1
(43) Pub. Date: Jul. 13, 2006

(54) Bending wave loudspeaker

(75) Inventor: David Magda Eddy Corynen, Dendermonde (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHLIPS ELECTRONICS N.V., Eindhoven (NL)

(21) Appl. No.: 10/547,592

(22) PCT Filed: Feb. 27, 2004
(86) PCT No.: PCT/IB04/50158

§ 371 Date: Sep. 1, 2005

(30) Foreign Application Priority Data
Mar. 7, 2003 (EP) 03100578.8

(51) Int. Cl. H04R 25/00

(52) U.S. Cl. 381/152; 381/431

(57) ABSTRACT

A loudspeaker comprising an acoustic panel (1) having two substantially parallel main surfaces (5A, 5B) and comprising an electrical exciter (3) arranged on one of said main surfaces. The panel produces acoustic radiation upon energization of the exciter, at least subsequently as a result of bending waves produced in the panel. In order to improve the energy response of the loudspeaker, the panel has a tuning area (21) extending opposite the exciter, which tuning area has a fundamental resonance frequency which is lower than the fundamental resonance frequency of any similar area in the rest of the panel, if determined under the same conditions.

The invention relates to a loudspeaker comprising an acoustic panel having two main surfaces and comprising an electrical exciter arranged on one of said main surfaces, the panel producing acoustic radiation upon energization of the exciter, at least subsequently as a result of bending waves produced in the panel.

PCT patent application WO 99/67974 discloses a loudspeaker having an anisotropic plane or slightly curved diaphragm formed from two skins and a structure which extends between these skins. The diaphragm has a longitudinal bending strength which is greater than the transverse bending strength. An extruded diaphragm of a polypropylene copolymer having walls which extend between the skins is mentioned as a possible version. The diaphragm carries one or more exciters.

PCT patent application WO 97/09842 discloses a panel-shaped loudspeaker, which has a panel comprising a sandwich-like structure of a rigid cellular core, particularly a honeycomb structure, and two skins enclosing the core and glued to the core. A light metal and a synthetic material are mentioned as materials for the core. The loudspeaker further has one or more exciters arranged at such locations with respect to the panel that bending waves are produced in the panel at given frequencies, which results in an irregular pattern of regions with more vibration activity and regions with less vibration activity, which is characteristic of the loudspeaker of the type to which the present patent document relates and which is commonly referred to as a flat-panel loudspeaker.

The known panel-shaped loudspeakers suffer from the problem that their acoustical performance has a nasal component. Measurements have revealed that the power response of the known panel-shaped loudspeakers shows a peak in the mid-frequency range between about 2 kHz and about 8 kHz.

It is an object of the invention to provide a panel-shaped loudspeaker of the type defined in the opening paragraph, which produces a neutral sound during use.

This object is achieved with the loudspeaker according to the invention, which is characterized in that the panel has a tuning area extending at least partly opposite the exciter, which tuning area has a fundamental resonance frequency which is lower than the fundamental resonance frequency of any similar area in the rest of the panel, if determined under the same conditions. Such a determination may be a measurement or a calculation. Listening tests have revealed that the applied measure yields a substantial improvement of the reproduced sound. Measurements have shown that the applied measure offers the possibility to obtain a substantially flat energy response. This is favorable because of the fact that a balanced energy response gives a better sound performance.

The fundamental resonance frequency f₀ of a circular membrane area supported at its circumference is given by the equation

$${f}_{0} \approx \frac{1}{{r}^{2}} \cdot \sqrt{\frac{B}{μ}}$$

with r being the radius (in m) of the relevant area; B the bending stiffness (in Nm) of the material in the area; μ the surface density (in kg/m²) of the area. The parameters which can be used to tune the membrane area's fundamental resonance frequency are thus the bending stiffness (B), the surface density (μ) and the radius (r). The efficiency of the power reduction is proportional to the radius of the relevant area.

Experimentally it has appeared that the best results are reached if the fundamental resonance frequency of the tuning area, i.e. the panel area which is situated opposite to the exciter, is lower than 1.5 kHz. Therefore it is preferred to choose B, μ and r so that:

$$\frac{1}{{r}^{2}} \sqrt{\frac{B}{μ}} < 1500 Hz .$$

<1500 Hz.

In a practical embodiment, the panel is provided with a cut-off or an opening located opposite the exciter and includes a membrane having a membrane section covering said cut-off and opening, respectively, wherein the tuning area is formed by the membrane section. The membrane section can extend, in the form of a foil, in or over said cut-off or opening wherein the membrane may be an integral portion of the panel or may be adhered to portions of the panel, e.g. by means of an adhesive. Generally, the cut-off or opening will have a cylindrical shape and the membrane section will be disc-shaped.

Suitable materials for the membrane section are e.g. certain thermoplastics, such as polyvinylchloride, polyethyleneterephtalate or glass fiber (reinforced) epoxies. A suitable adhesive is e.g. an acrylic adhesive and such an adhesive may be applied in the form of a tape.

It has appeared that a reduction of the 3^{rd} harmonic distortion can be achieved by the loudspeaker according to the invention when the tuning area is provided with a tuning aperture. In the case of the above-mentioned practical embodiment, this means that the membrane section is provided with a relatively small opening opposite the exciter. Alternatively, or in addition to the tuning aperture, the tuning area may be provided with a layer of felt or a similar material.

In the case of said practical embodiment, the panel preferably comprises two walls forming the main surfaces of the panel and connected to each other by a structure of parallel strip-shaped partitions extending between the walls, wherein the walls and the partitions are made of a material which, used in the panel, has a critical damping which is at least 2.5% of the critical damping of the relevant material used in the panel. Mechanically, such a panel is anisotropic, wherein the panel can be bent relatively easily around an axis extending parallel to the partitions and is relatively bending-stiff about an axis oriented transversely thereto. A loudspeaker with such a panel is known per se from PCT patent application WO 01/18132 (herewith incorporated by reference). Such a loudspeaker has already been marketed for some years and is considered to be known to those skilled in the art. A suitable material for the walls and the partitions of the panel is a polypropylene, preferably a co-polymer of polypropylene.

Although the loudspeaker known from WO 01/18132 A2 has a favorable acoustical behavior, at a broad range of frequencies, tests have revealed that the panel, when provided with the membrane as defined in claim 3, has an essentially improved acoustical behavior, i.e. regular acoustic energy response.

It is to be noted that the loudspeaker according to the invention is suitable for sound reproduction in hifi, home, automotive and multimedia-audio systems. The invention also relates to a panel evidently intended for use in the loudspeaker according to the invention.

With reference to the claims, it is noted that various combinations of characteristic features defined in the claims are possible.

The invention will now be described in more detail, by way of example, with reference to the drawings, in which

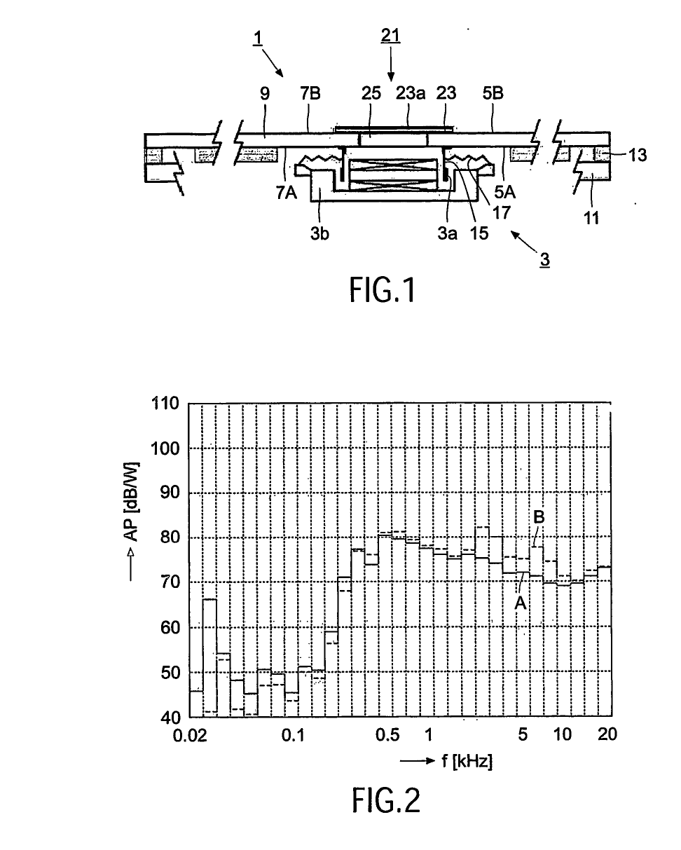

FIG. 1 shows diagrammatically a first embodiment of the panel-shaped loudspeaker according to the invention in a cross-sectional view,

FIG. 2 shows a first graphical representation of results of acoustical power measurements performed on an embodiment of the panel applied in the loudspeaker of FIG. 1 and a known panel,

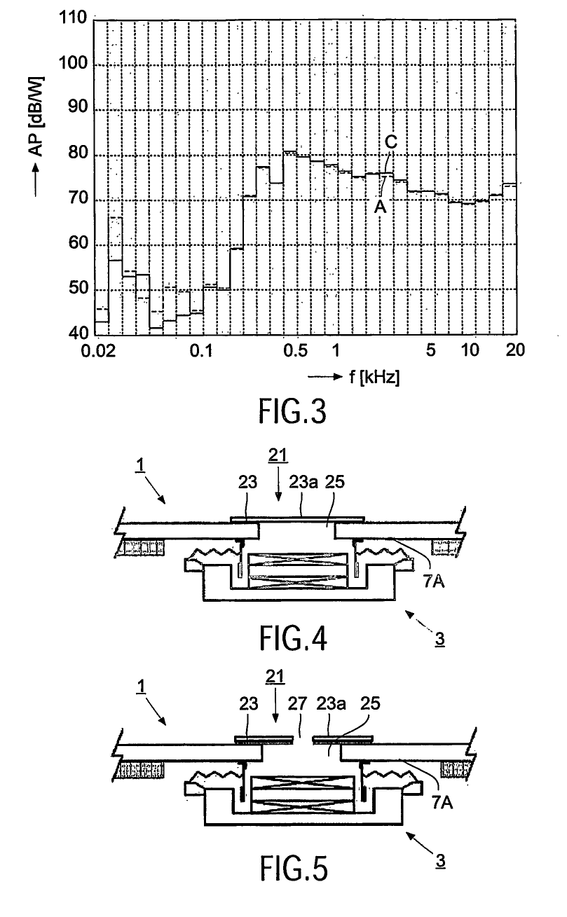

FIG. 3 shows a second graphical representation of results of acoustical power measurements performed on two different embodiments of the panel of the loudspeaker according to the invention,

FIG. 4 to FIG. 9 show diagrammatically several embodiments of the loudspeaker according to the invention in cross-sectional views,

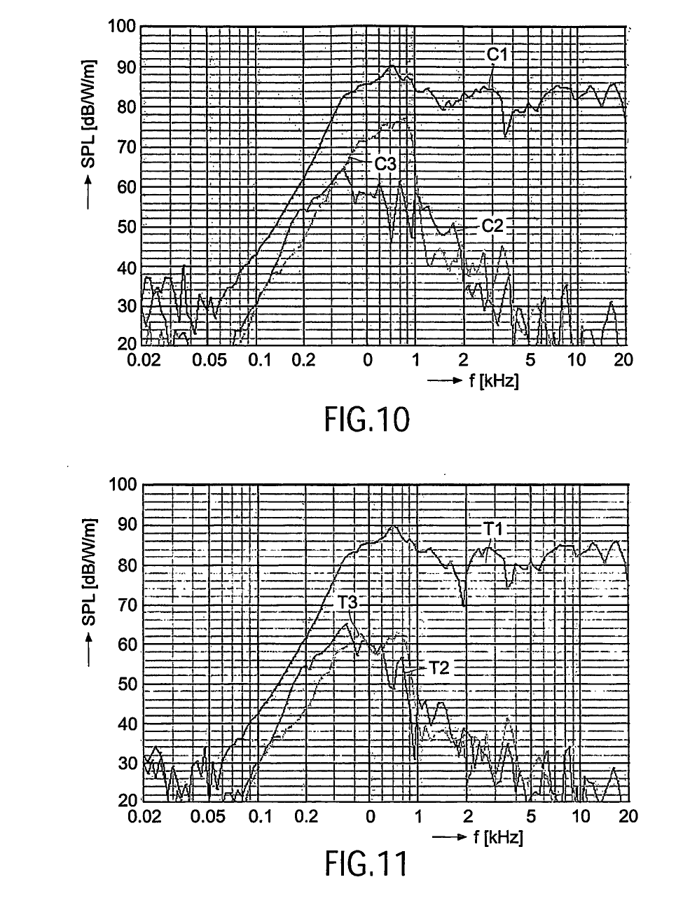

FIG. 10 shows a third graphical representation of results of sound pressure level measurements performed on the panel used in the loudspeaker of FIG. 4,

FIG. 11 shows a fourth graphical representation of the results of sound pressure level measurements performed on the panel used in the loudspeaker of FIG. 5,

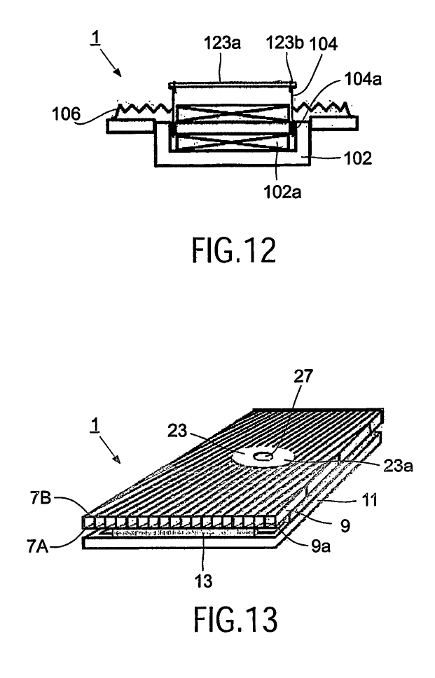

FIG. 12 shows diagrammatically a test device, and

FIG. 13 shows diagrammatically a panel provided with a structure of parallel strip-shaped partitions.

The embodiment of the panel-shaped loudspeaker according to the invention shown in FIG. 1 has a panel 1, in this example a flat panel, and an exciter 3 for driving the panel 1. The panel 1 has two main surfaces 5A and 5B formed by two main walls 7A and 7B. An intermediate structure 9 extends between the main walls 7A and 7B and connects these walls to each other. In this embodiment, the structure 9 includes parallel strip-shaped partitions arranged and constructed as disclosed in the above-mentioned PCT patent application WO 01/18132. The walls 7A and 7B and the structure 9 form one product, manufactured by extruding a polypropylene co-polymer. In this example, the panel 1 has an overall thickness of about 1.5 mm and the applied polypropylene co-polymer has an internal damping of 2.9%. Other panels and structures are possible within the scope of the invention.

The loudspeaker shown in FIG. 1 further has a frame 11 to which the panel 1 is secured by a suitable connection means, such as compliant strip elements 13 of a soft material, such as a soft rubber or a rubber-like material. The strip elements 13, which are situated at the outlines of the panel 1, have one side glued to a wall portion of the panel 1 and have another side glued to a frame portion of the frame 11.

The exciter 3 is disposed adjacent to the main surface 5A and, in the present example, it is provided with an electromagnetic exciter system including an exciter coil 3a on a coil former 15, secured to the wall 7A of panel 1, and a magnetic unit 3b for cooperating with the coil former 15 through an air gap. The magnetic unit 3b comprises a permanent magnet and a magnetic yoke and is suspended from the coil former 15 by a resilient suspension means 17. In principle, the exciter system may be a known system, e.g. the exciter system as disclosed in the above-mentioned PCT patent application WO 01/18132.

The loudspeaker shown in FIG. 1 has the characteristic feature that the panel 1 has a tuning area 21 which has a fundamental resonance frequency which is lower than the fundamental resonance frequency of any similar area elsewhere in the panel, under the condition that the measurements take place under the same circumstances.

Such measurements may be done with a device as diagrammatically depicted in FIG. 12. This device comprises a stationary portion 202a, and a—hollow—movable portion 104 with a voice-coil 104a. Both portions 102 and 104 are flexibly connected to each other by a flexible means 106, such as a spider. The electrical impedance of the device can be measured by energizing the voice-coil 104a After fixing the circumferential edge 123b of a membrane portion 123a to be tested to the movable portion 104, the electrical impedance can be measured again. The mechanical impedance, and thus the fundamental resonance frequency, of the membrane portion 123a can be derived in a manner known per se from the differences between both measurements.

As an alternative, the fundamental resonance frequency of a membrane portion can be calculated. By way of example, the calculation conditions are given for a circular membrane portion which is supported at its contour.

$${f}_{0} \approx \frac{0 \text{,} 3 t}{{r}^{2}} \sqrt{\frac{E}{ρ ( 1 - {v}^{2} )}} of {f}_{0} \approx \frac{1}{{r}^{2}} \cdot \sqrt{\frac{B}{μ}} with B = \frac{{Et}^{2}}{12 ( 1 - {v}^{2} )} and μ = pt$$

E: Young's modulus in N/m² (Pa)
B: Bending stiffness in Nm
p: Volume density in kg/m³
μ: Surface density in kg/m²
t: thickness in m
r: effective membrane radius in m
v: Poisson's ratio (˜0,3).

In the present embodiment, the tuning area 21 is formed by a membrane section 23a which is a part of a membrane 23 secured by means of a glue to the main wall 7B of the panel 1. The membrane section 23a covers a cut-off 25 provided in the panel 1 and located opposite the exciter 3. In this way, the tuning area 21 extends opposite the exciter 3. The membrane 23 and thus also its section 23a is formed by a sheet of polyvinylchoride. The fundamental resonance of the tuning area 21 is 89 Hz in this case; therefore

$$\frac{1}{{r}^{2}} \sqrt{\frac{B}{μ}} = 89 Hz .$$

=89 Hz. Upon exciting the exciter coil 3a, bending waves are launched into the panel 1 to cause resonance to produce the acoustical output.

The graphical representation in FIG. 2 shows the results of acoustical power measurements carried out at different frequencies on the embodiment depicted in FIG. 1, i.e. on a loudspeaker with a tuning area formed by a sheet of polyvinylchloride and having a fundamental resonance of 89 Hz, and on a loudspeaker of the kind disclosed in PCT patent application WO 01/18132, i.e. a loudspeaker without a tuning area. Apart from the fact that the panel of the known loudspeaker has no tuning area, both panels are the same, i.e. they have the same dimensions, the same structure and are made of the same panel material. The fundamental resonance frequency of an imaginary area of the known panel corresponding to the turning area of the loudspeaker according to the invention is 4465 Hz. In the representation, the acoustical power (AP) in dB/W is plotted along the vertical axis and the frequency in kHz is plotted along the horizontal axis. The curve A represents the measurements carried out on the loudspeaker according to the invention and the (dashed) curve B represents the measurements carried out on the known loudspeaker. FIG. 2 clearly shows that the curve A is in the frequency range between 2 kHz and 8 kHz of a considerably more regular shape than the curve B. The power peaks which are present in the curve B at frequencies of about 2.5 and 6 kHz are absent in the curve A. Due to the absence of such power peaks, the sound generated by the loudspeaker is of a neutral nature.

The graphical representation in FIG. 3 depicts a curve C which is based on the results of acoustical power measurements carried out at different frequencies on an embodiment of the loudspeaker according to the invention which is provided with a tuning area formed by a sheet of polyethyleneterephthalate. This tuning area has a fundamental resonance frequency of 584 Hz. Similarly as in FIG. 1, the acoustical power is plotted along the vertical axis and the frequency is plotted along the horizontal axis. FIG. 3 also depicts the curve A shown in FIG. 1, however, now in a dashed line.

Apart from the fact that the membranes, and thus the membrane sections, are made of different materials, the panels of both embodiments are identical. A comparison made between the curves A and B shows that their shapes are practically the same. This means that there is hardly any difference in sound performance, in other words, both embodiments of the loudspeaker according to the invention are able to produce a naturally sounding output.

Several embodiments of the loudspeaker according to the invention will be described hereinafter with reference to FIGS. 4 to 9. For the construction elements, which are similar to the corresponding elements of the embodiment shown in FIG. 1, the same reference signs as used for the description of the embodiment of FIG. 1 will be applied.

The embodiment depicted in FIG. 4 comprises a panel 1 and an exciter 3 fixed to a main wall 7A of the panel 1. The panel 1 is provided with a cylindrical cut-off 25 located opposite the exciter 3, a membrane 23 covering this cut-off 25. The membrane 25 is sealed to the panel 1 and includes a disc-like membrane section 23a which has a fundamental resonance frequency which is lower than the fundamental resonance frequency of any similar area in the rest of the panel 1, and which thus forms a tuning area 21. Apart from the presence of a tuning aperture 27 in the form of an opening, particularly a central opening, in the membrane section 23a, the alternative embodiment shown in FIG. 5 is identical to the embodiment depicted in FIG. 4. This embodiment is also shown in a perspective view in FIG. 13. As can be seen in FIG. 13, the panel 1 has two main walls 7A and 7B and an intermediate structure 9 extending between and connecting the main walls. The structure 9 comprises parallel strip-shaped partitions 9a.

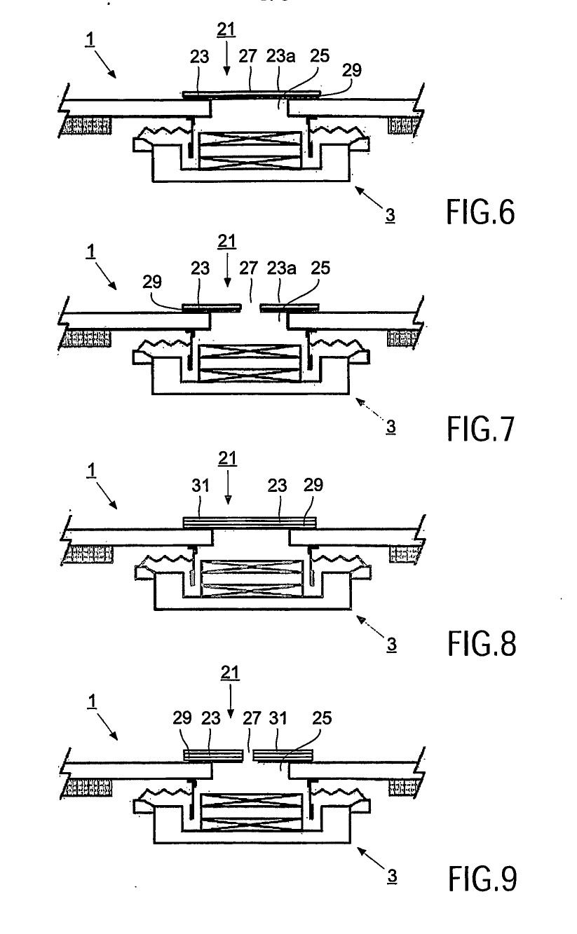

The embodiment depicted in FIG. 6 comprises a panel 1 and an exciter 3 attached to a main wall 7A of the panel 1, the panel 1 being provided with an opening 25 located opposite the exciter 3. A membrane 23, which covers the opening 25, has a membrane section 23a positioned opposite the exciter 3. The membrane 23 is provided on an adhesive carrier 29 by means of which it is adhered to the panel 1. The membrane section 23a is of such a nature that its fundamental resonance frequency is low enough to comply with the requirements as defined in claim 1. The alternative embodiment shown in FIG. 7 is similar to the embodiment of FIG. 6, but is provided with a tuning aperture 27 in the form of an opening in the membrane section 23a.

The embodiments depicted in FIGS. 8 and 9 are similar to the embodiments in FIGS. 6 and 7, respectively, but the membrane 23 is now covered with a layer 31 of a felt-like material.

The parts of the loudspeaker shown in FIGS. 4 to 9, which have not been mentioned, may have a construction which is similar to that of corresponding parts in the embodiment of FIG. 1.

The graphical representation in FIG. 10 shows the results of sound pressure level measurements performed on the panel used in the loudspeaker of FIG. 4. The tuning area of the panel has a fundamental resonance frequency of 200 Hz.

In the representation, the sound pressure level (SPL) in dB/W/m is plotted along the vertical axis and the frequency in kHz is plotted along the horizontal axis. The representation includes three curves C1, C2 and C3 relating to the fundamental harmonic, the 2^{nd} harmonic and the 3^{rd} harmonic, respectively. The measurements were performed at a distance of 1 m from the panel with a power of 1 W supplied to the loudspeaker (P_{ref}=20 μPa).

The same measurements were performed on the panel of the embodiment of FIG. 5. The results of these measurements are shown in the graphical representation depicted in FIG. 11. Similarly as in FIG. 10, the sound pressure level is plotted along the vertical axis and the frequency is plotted along the horizontal axis. The representation includes three curves corresponding to the curves C1, C2 and C3 in FIG. 10, but now labeled by the reference signs T1, T2 and T3, respectively. A comparison made between the curves C1 to C3 and the curves T1 to T3 shows that the presence of a tuning aperture reduces the 3^{rd} harmonic distortion and thus further improves the sound quality of the loudspeaker according to the invention.

It is to be noted that the invention is not limited to the embodiments shown. For example, several variations are possible within the scope of the invention, notably as regards dimensions, structures and materials of panel and membrane. Furthermore, an exciter of a different type, such as a piezoelectric type, may be used instead of the electromagnetic exciter.

1. A loudspeaker comprising an acoustic panel (1) having two substantially parallel main surfaces (5A, 5B) and comprising an electrical exciter (3) arranged on one of said main surfaces, the panel producing acoustic radiation upon energization of the exciter, at least subsequently as a result of bending waves produced in the panel, wherein the panel has a tuning area (21) extending opposite the exciter, which tuning area has a fundamental resonance frequency which is lower than the fundamental resonance frequency of any similar area in the rest of the panel, if determined under the same conditions.

2. A loudspeaker as claimed in claim 1, wherein the fundamental resonance frequency of the tuning area is lower than 1500 Hz.

3. A loudspeaker as claimed in claim 1, wherein the panel is provided with a cut-off (25) located opposite the exciter and includes a membrane (23) having a membrane section (23a) covering said cut-off, the tuning area being formed by the membrane section.

4. A loudspeaker as claimed in claim 1, wherein the tuning area is provided with a tuning aperture.

5. A loudspeaker as claimed in claim 1, wherein the tuning area is provided with a layer of a felt-like material.

6. A loudspeaker as claimed in claim 3, wherein the panel has two walls forming the main surfaces and connected to each other by an intermediate structure of parallel strip-shaped partitions extending between the walls, the walls and the partitions being made of a material which, used in the panel, has an internal damping which is at least 2.5% of the critical damping of the relevant material used in the panel.

7. A panel presenting the features of the panel disclosed in any one of the preceding claims and being thus constructed and evidently intended for use in the loudspeaker as claimed in claim 1.
